(19) United States
(12) Patent Application Publication
(10) Pub. No.: US 2025/0241224 A1
(43) Pub. Date: Jul. 31, 2025

(54) METHOD TO MANAGE THE SEED FEEDING PROCESS OF A PLANTER THROUGH A SEED TENDER

(71) Applicant: DINAMICA GENERALE S.P.A., POGGIO RUSCO (MN) (IT)

(72) Inventors: Nicola BERTOLANI, Poggio Rusco (MN) (IT); Anna GHIRALDI, Poggio Rusco (MN) (IT)

(21) Appl. No.: 19/041,094

(22) Filed: Jan. 30, 2025

Related U.S. Application Data
(60) Provisional application No. 63/627,284, filed on Jan. 31, 2024.

(51) Int. Cl. A01B 79/00; A01C 7/08; A01C 15/00; G01G 13/02

(52) U.S. Cl. CPC A01B 79/005; A01C 7/08; A01C 15/005; G01G 13/02

(57) ABSTRACT

A method to manage the seed feeding of at least one planter through a seed tender for allowing the planter to sow a seed into the soil of a field, the planter comprising a plurality of hoppers for sowing the seed and the seed tender comprising a reservoir for the seed and a weighting system. The weighting system acquires input data relating to the seed to be sow a to the hoppers and weight measurements of the reservoir content. The weighting system processes the input data and the weight measurements in order to obtain output data according to the following steps executed for each feeding cycle of the hoppers of a plurality of feeding cycles: determining an actual hopper capacity of a non empty single hopper, computing an actual area sown by the planter with the preceding feeding cycle as a function of the input data and the actual hopper capacity, and computing, as output data, an area still to be sown of the field and/or a projected total number of feeding cycles required to complete the sowing of the field as a function of the number of feeding cycles already performed and the actual area sown by the planter with the feeding cycles already performed. The output data is the displayed to the operator to help him to manage the feeding process.

### CROSS-REFERENCE TO RELATED APPLICATIONS

This patent application claims priority from U.S. provisional application No. 63/627,284 filed on Jan. 31, 2024, the entire disclosure of which is incorporated herein by reference.

### TECHNICAL FIELD

The present invention relates to a method to manage the seed feeding process of a planter through a seed tender.

In particular, the invention finds advantageous but not exclusive application in feeding a planter towed by a tractor and comprising a plurality of hoppers for the seed, to which the description below explicitly refers without any loss of generality thereby.

### BACKGROUND

A planter is a farm implement used in farms that grow grain and forage-type crops. The function of the planter is to sow seeds into soil along a row or stripe of proper width for creating evenly spaced crop rows or stripes and metered seed gaps. The planter is usually towed by a tractor and comprises many containers for the seed to be sown. Each container comprises a box or bin and a respective lower hopper for the dropping of the seed into the soil. For that reason, in the technical field of farm implements these containers are also shortly named “hoppers”.

It is also known to use a seed tender for feeding seed into the hoppers of the planter. A seed tender is a farm equipment comprising a wagon provided with a big reservoir for seed, allowing for bulk quantities of seeds to be directly fed into the hoppers of the planter. The advantage of feeding the planters by means of seed tenders is to reduce the downtime for planting, which is very helpful in case of large fields to be sown, especially during short planting windows.

Known seed tenders are normally fed manually by an operator and are provided with weighting systems. In case of a planter with many hoppers, the operator can set, on the weighing system of the seed tender, a target weight for the seed to be fed in each hoppers of the planter, and the seed tender is configured to stop the loading of seed into the hoppers as soon as the target weight is reached. Moreover, in case the planter is fed while its hoppers are not completely empty, it is possible to reduce the target weight for the hoppers. Everything else has to be done manually under the strictly control of the operator.

Often, operators do not know in advance the capacity of the hoppers of the planters and so they are not able to set the target weight for the hoppers of the planter. Moreover, the target weight should be calculated on the basis of the specific weight of the seed, which may change with respect to the known nominal values (provided by the seed producer) due to the ambient conditions, such as humidity and temperature.

In order to facilitate feeding operations, the seed tender is normally provided with a wireless remote control capable of sending command to a control unit onboard of the seed tender, said control unit being configured to control actuators of the seed tender. It is well known that remote controls are often critical in terms of reliability, often due to their misuse. For this reason, in order to allow the operator to work even in case of failure of the remote control, the seed tender may be provided with spare cables so as to connect the remote control by cable to the actuators control unit of the seed tender.

### SUMMARY

The purpose of the present invention is to provide a method to facilitate and make more efficient the seed feeding process of a planter through a seed tender, which is free of the drawbacks described above and, at the same time, is easy and economical to produce.

In accordance with this invention, a method to manage the seed feeding of at least one planter through a seed tender for allowing the planter to sow a seed into the soil of a field, a weighting system for a seed tender for the feeding of at least one planter for allowing it to sow a seed into the soil of at least one field, and a managing system to manage the seed feeding of at least one planter through a seed tender for allowing the planter to sow a seed into the soil of at least one field are provided according to that set forth in the appended set of claims.

The claims describe preferred embodiments of this invention to be considered an integral part of this description.

### BRIEF DESCRIPTION OF THE DRAWINGS

This invention will now be described with reference to the attached drawings that illustrate a non-limiting embodiment thereof, in which:

FIG. 1 illustrates a perspective view of a planter comprising a plurality of hoppers provided with hoppers for sowing seed;

FIG. 2 illustrate a perspective view of a seed tender suitable for feeding bulk quantities of seed directly into the hoppers of the planter; and

FIG. 3 illustrates a block diagram of a managing system to manage a seed feeding of the planter, the managing system comprising a weighting system mounted on the seed tender.

### DESCRIPTION OF EMBODIMENTS

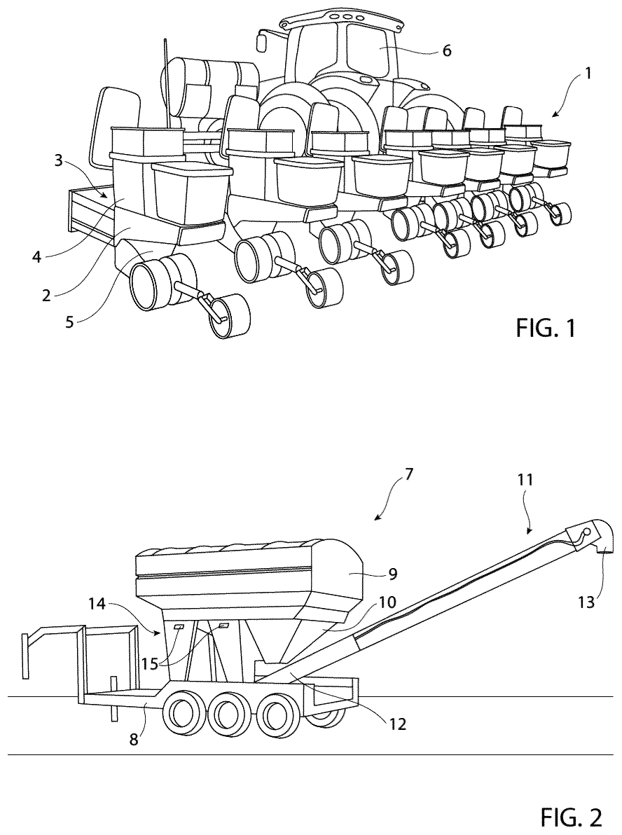

In FIG. 1, reference number 1 generically indicates, as a whole, a planter comprising a plurality of trolleys 2 arranged in a row and each provided with a respective container 3 for the seed to be sown. Each container 3 comprises a box or bin 4 and a respective lower hopper 5 shaped as a hopper for the dropping of the seed into the soil. The planter is typically towed by a tractor 6. Since in the technical field of farm implements these containers 3 are commonly named “hoppers”, for the sake of simplicity, the container 3 will be thereinafter named hopper and referenced with the same number 3.

In FIG. 2, reference number 7 generically indicates, as a whole, a seed tender comprising a wagon 8, a big reservoir 9 mounted on the wagon 8 in an elevated position for containing a large quantity of a seed, a hopper 10 communicating with the bottom of the reservoir 9 for receiving the seed from the reservoir 9, and a conveyor 11 having a proximal end 12 arranged for receiving the seed coming out of the hopper 10 and a distal end 13 for discharging the seed in the hoppers 3 of the planter 1. The seed tender 7 is normally towed by the same tractor 6 used for towing the planter 1. The seed tender 7 is typically used for feeding the hoppers 3 with the seed according to a feeding cycle, by placing the distal end 13 of the conveyor 11 above one hopper 3 at a time.

With reference always to FIG. 2, the seed tender 7 comprises a weighting system 14, which comprises gravimetric sensors 15, for instance load cells, applied to the reservoir 9 for measuring the weight of the reservoir content. In particular, the reservoir 9 is mounted on the wagon 8 with the interposition of the gravimetric sensors 15.

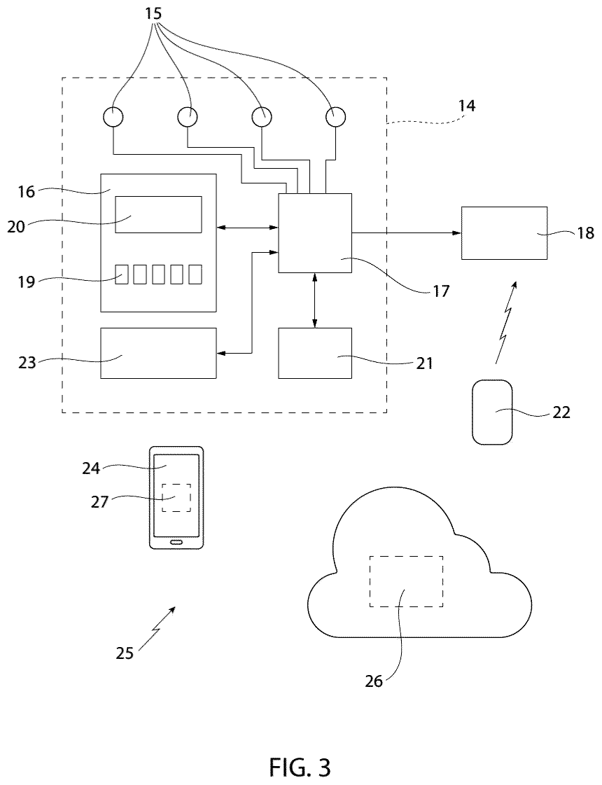

With reference to FIG. 3, the weighting system 14 further comprises a human-machine interface 16, which comprises a keypad 19 and a display 20 for acquiring input data, and a processing and control unit, which is called weighing control unit 17 hereinafter.

The seed tender 7 typically comprises actuators (not sown), for instance those related to the operation of the conveyor 11, and an actuators control unit 18, which in turn comprises electronic drivers for driving said actuators.

The control unit 17 is communicatively connected to the human-machine interface 16 and is configured to process the input data and the weight measurements in order to provide output data and comprises a memory 21 for supporting the data processing and saving the output data, as will be described in details hereinafter. For the purpose of processing the weight measurements, the control unit 17 is also configured to control the operation of the seed tender 7, in particular to control the actuators control unit 18, as will be described in details hereinafter.

The actuators control unit 18 typically comprises a wireless communication module (not shown) for communicating with a wireless remote control 22 of the seed tender 7 so that an operator can send commands to the actuators of the seed tender 7 by means of the wireless remote control 22.

The weighting system 14 further comprises a wireless communication module 23 for communicating with a personal communication device 24 of a common type, such as a smartphone or a tablet. For instance, the wireless communication module 23 is a Bluetooth module, in particular a Bluetooth Low Energy module.

The weighting system 14 is part of a managing system 25 to manage the seed feeding of the planter 1 through the seed tender 7 for allowing the planter 1 to sow a seed into the soil of at least one field.

In particular, in addition to the weighting system 14, the managing system 25 comprises a cloud server 26 and software application 27, i.e. an App, which is installable on the memory of the personal communication device 24 and is designed for configuring the personal communication device 24 to be used as a remote control and/or as a gateway between the weighting system 14 and cloud server 26. In more detail, the software application is designed for implementing, on personal communication device 24, at least one of the following functions:
a remote control function for allowing to use the personal communication device 24 as a remote control for controlling the operation of the electronic drivers control unit 18, so as to control the operation of the actuators of the seed tender 7, and the operation of weighting control unit 17;
a data transfer function for transmitting the output data to the cloud server 26;
an equipment maintenance function for sending warning messages to the weighting system 14; and
a reporting function for providing, for instance, statistical and traceability reports on the operations performed by planter 1, said reports comprising efficiency data in terms of actual quantity of seed sown vs. the optimal quantity of seed sown, actual number of feeding cycles performed vs. the optimal (minimum) number of feeding cycles performed; efficiency data can then be used in order to modulate all parameters in terms of seeding and number of feeding cycles required for sowing a specific field in the future.

The remote control function allows to use the personal communication device 24 as a back-up device in case of failure of the wireless remote control 22.

The managing system 25 implements a method to manage the seed feeding of the planter 1 through the seed tender 7 for allowing the planter 1 to sow a seed into the soil of a field. In general, according to the method, input data are acquired by the human-machine interface 16. In other words, an operator in charge of using the seed tender 7 for feeding the planter 1, starts the feeding process by inserting input data by means of the keypad 19 and the display 10. Weight measurements of the content of the reservoir 9 are acquired by the gravimetric sensors 15. The input data and the weight measurements are processed by the weighting control unit 17 in order to obtain output data. The output data is then displayed trough the display 20 of the human-machine interface 16.

The input data concerns the field being sown, the seed used, and the planter used. The output data concerns the feeding process of the planter 1 that have to sow the seed in the field. The output data help an operator to optimally manage the feeding process.

In general, the hardware structure of a seed tender need not to be designed for containing a specific seed and/or feeding a specific planter. Therefore, the weighting control unit 17 can be configured, for instance, to process input data of different fields and different seeds for obtaining output data for different planters and different fields so that the planters can sow different fields at the same time. Moreover, taking into account that all the hoppers 3 of the planter 1 are fed by performing one feeding cycle, in general a plurality of feeding cycles are needed for allowing the planter 1 to sow the entire field. The feeding cycles are performed in sequence alternating with sowing cycles of the seeder, i.e. each sowing cycle follows a feeding cycle.

Therefore, the input data and the step of processing the input data and the weight measurements in order to obtain output data will be described hereinafter with reference to the i-th field, the k-th planter (coinciding with the planter 1), the j-th seed and the n-th feeding cycle.

The input data comprise a total area of the field TA₍ᵢ₎, a seeding surface density Q₍ⱼ₎, a seed grain weight WG₍ⱼ₎, a number of hoppers of the planter NH₍ₖ₎. Typically, the total area of the field TA₍ᵢ₎ is expressed in Acres, the seeding surface density Q₍ⱼ₎ is expressed, in the packages of the seed, in number of grains of the j-th seed to be sown per surface measurement unit (Acre), and the seed grain weight W₍ⱼ₎ is expressed, in the packages of the seed, as inverse seed unitary mass, i.e. the number of grains of the j-th seed per weight measurement unit (Pound).

The above input data allow to calculate the total number of seed grains required for sowing the i-th field as

$$T {N}_{( j , i )} = T {A}_{( i )} \cdot {Q}_{( j )} \qquad [ 1 ]$$

and the total weight of the j-th seed required for sowing the i-th field as

$${TWF}_{( i , j )} = \frac{T {N}_{( j , i )}}{{W}_{( j )}} . \qquad [ 2 ]$$

A maximum total weight of the j-th seed fed into the k-th planter in one feeding cycle is calculated as

$${TWP}_{Max ( j , k )} = H {C}_{Max ( j , k )} \cdot {NH}_{( k )} \qquad [ 3 ]$$

where HC_{Max(j,k)} is a maximum hopper capacity of k-th planter for the j-th seed, i.e. the maximum capacity of each hopper typically expressed in weight measurement unit (Pound).

According to a first embodiment, the maximum hopper capacity HC_{Max(j,k)} is acquired as part of the input data. This is possible if the operator working with seed tender 7 knows this specific parameter of the k-th planter. According to two alternatives, the maximum hopper capacity HC_{Max(j,k)} is expressed in weight measurement unit (Pound) or in volume measurement unit (U.S. gallon). According to the second alternative, the input data comprise also a seed density SD₍ⱼ₎, which is typically expressed in pounds per US gallon. In this case, A maximum total weight of the j-th seed fed into the k-th planter in one feeding cycle can be calculated as follows:

$${TWP}_{Max ( j , k )} = H {C}_{Max ( j , k )} \cdot {SD}_{( j )} \cdot {NH}_{( k )} . \qquad [ 4 ]$$

According to a second embodiment, the maximum hopper capacity HC_{Max(j,k)} is determined during the processing of the input data and the weight measurements. In particular, the maximum hopper capacity HC_{Max(j,k)} is determined by obtaining a hopper capacity on the basis of weight measurements acquired during a feeding operation of an initially empty single hopper 3 of the planter 1, i.e. when said single hopper 3 is empty at the starting of said feeding operation.

In more detail, the weighting system 14 is configured to implement a self-learning function for automatically obtaining the hopper capacity. The self-learning function is executed when a specific request is acquired through the human-machine interface 16 and comprises the following steps:
the weighting control unit 17 operates the seed tender 7 so as to feed the single hopper 3 until it is full;
the gravimetric sensors 15 measure a first weight and a second weight of the content of reservoir 9 before and, respectively, after the feeding of the single hopper 3; and
the weighting control unit 17 calculates the hopper capacity as the difference between the first weight and the second weight.

The self-learning function is then advantageously executed before performing the first feeding cycle, i.e. when all the hoppers 3 are certainly empty, for determining the maximum hopper capacity HC_{Max(j,k)}.

The maximum area of the i-th field that can be sown by the k-th planter with the j-th seed with one feeding cycle, i.e. by assuming that all the hoppers 3 are empty at the start of each feeding cycles, hereinafter indicated with SS_{Max(j,k)}, is defined as follows

$${SS}_{Max ( j , k )} = \frac{{TWP}_{Max ( j , k )}}{{TWF}_{( i , j )}} \cdot {TA}_{( i )} . \qquad [ 5 ]$$

By combining the formulas [2] and [3] into the formula [5], it follows that the maximum area of the i-th field that can be sown by the k-th planter with the j-th seed with one feeding cycle can be computed as a function of a subset of the input data, i.e. the seeding surface density Q₍ⱼ₎, the seed grain weight W₍ⱼ₎ and the number of hoppers of the planter NH₍ₖ₎, and of the maximum hopper capacity HC_{Max(j,k)}, in particular according to the following new formula

$${SS}_{Max ( j , k )} = {HC}_{Max ( j , k )} \cdot \frac{{W}_{( j )} \cdot {NH}_{( k )}}{{Q}_{( j )}} , \qquad [ 6 ]$$

which shows that the maximum area sowable with one feeding cycle does not depend on the total area of the i-th field TA₍ᵢ₎.

The minimum total number of feeding cycles required for sowing the complete i-th field by the k-th planter with the j-th seed, hereinafter indicated with TNFC_{Min(i,j,k)}, is computed as a function of the input data, in particular the subset on the input data mentioned above, the maximum hopper capacity HC_{Max(j,k)} and by assuming that at the start of each feeding cycle the hoppers are empty. In particular, said minimum total number of feeding cycles is calculated with the formula

$${TNFC}_{Min ( i , j , k )} = Roundup ( \frac{T {A}_{( i )}}{{SS}_{Max ( j , k )}} ) , \qquad [ 7 ]$$

wherein “Roundup” is the function round up to the nearest integer.

The minimum total number of feeding cycles TNFC_{Min(i,j,k)} belongs to the output data.

Advantageously, the computation according to the formulas [6] and [7] is performed at the beginning of the feeding process, i.e. before performing the first feeding cycle since it depends only on input data and on the maximum hopper capacity. The maximum hopper capacity HC_{Max(j,k,)}, the maximum area sowable with one feeding cycle SS_{Max(j,k)} and the minimum total number of feeding cycles TNFC_{Min(i,j,k)} are saved in the memory 21.

The method to manage the seed feeding of the planter 1 through the seed tender 7 comprise the following further steps.

For at least one feeding cycle (a n-th feeding cycle), in particular for at least one feeding cycle starting from the second feeding cycle, and before starting that feeding cycle, a request of determining the actual hopper capacity is acquired by the human-machine interface 6 before performing that feeding cycle. In other words, the operator of the seed tender 7 might input said request into the weighting system 14, through the human-machine interface 16, when he decides to start a new feeding cycle of the planter 1 even if the hoppers 3 are not empty. This may occurs, for instance, if the planter 1 passes near the seed tender 7 and the operator believes the actual seed load of the hoppers 3 is not sufficient to complete the portion of the field that the planter 1 must sow before passing next to the seed tender 7 again.

The processing of the input data and the weight measurements comprises the step of incrementing a counter for each feeding cycle to record the number of feeding cycles performed at a certain time.

The processing of the input data and the weight measurements comprises the following further steps executed for each feeding cycle, from the second feeding cycle of the plurality of feeding cycles. In this regard, when a parameter is disclosed hereinafter as computed at the n-th feeding cycle, it means that the feeding cycles performed up to that point are n−1.

If the request of determining the actual hopper capacity is acquired in the n-th feeding cycle, then an actual hopper capacity HC_{(j,k,n)} of the k-th planter for the j-th seed before starting the n-th feeding cycle is determined on the basis of weight measurements acquired during a feeding operation of a initially non empty single hopper of the k-th planter before performing the n-th feeding cycle, and an actual area of the i-th field already sown with the j-th seed by means of the k-th planter with the (n−1)-th feeding cycle, i.e. the actual area already sown with a quantity of seed fed with the feeding cycle that precedes the current feeding cycle, hereinafter shortly named as actual area sown with the preceding feeding cycle and indicated with SS_{(j,k,n)}, is computed as a function of the input data and the actual hopper capacity HC_{(j,k,n)}.

In particular, the actual area sown with the preceding feeding cycle SS_{(j,k,n)} is computed as a function of a subset of the input data, i.e. the seeding surface density Q₍ⱼ₎, the seed grain weight W₍ⱼ₎ and the number of hoppers of the planter NH₍ₖ₎, in particular according to a formula derived from formula [6], that is:

$${SS}_{( j , k , n )} = {HC}_{( j , k , n )} \cdot \frac{{W}_{( j )} \cdot {NH}_{( k )}}{{Q}_{( j )}} . \qquad [ 8 ]$$

The actual hopper capacity HC_{(j,k,n)} is determined by obtaining a hopper capacity on the basis of weight measurements acquired during a feeding operation of a single hopper 3 of the planter 1 when said single hopper 3 is not empty at the starting of said feeding operation.

In particular, the actual hopper capacity HC_{(j,k,n)} is determined by using the self-learning function described above, before starting the (current) n-th feeding cycle.

The actual area sown with the preceding feeding cycle SS_{(j,k,n)} is saved in the memory 21.

If no request of determining the actual hopper capacity is acquired in the n-th feeding cycle, then the actual area sown with the preceding feeding cycle SS_{(j,k,n)} is determined as a function of the input data, an particularly the subset of input data mentioned above, and the maximum hopper capacity HC_{Max(j,k,)} already computed and saved in the memory 21. In other words, in this case the actual area sown with the preceding feeding cycle SS_{(j,k,n)} coincides with the maximum area sowable with one feeding cycle SS_{Max(j,k)}, which is already computed and saved in the memory 21.

The area of the i-th field still to be sown with the j-th seed by means of the k-th planter before staring the n-th feeding cycle, hereinafter indicated with S2S_{(i,j,k,n)}, and/or a projected total number of feeding cycles required to finalize the sowing with the j-th seed of the complete i-th field by means of the k-th planter before starting the n-th feeding cycle, hereinafter indicated with TNFC_{Proj(i,j,k,n)}, are computed as a function of the total area of the field TA₍ᵢ₎, the number of feeding cycles already performed, and the actual area of the i-th field already sown with the j-th seed by means of the k-th planter with the feeding cycles already performed. The number of feeding cycles already performed before starting the n-th feeding cycle is equal to n−1.

The area still to be sown of the field S2S_{(i,j,k,n)} is computed as a difference between the total area of the field TA₍ᵢ₎ and the actual area of the i-th field already sown with the j-th seed by means of the k-th planter with the feeding cycles already performed. In particular, the area still to be sown of the field S2S_{(i,j,k,n)} is calculated with the formula

$$S 2 {S}_{( i , j , k , n )} = T {A}_{( i )} - {\sum }_{l = 1}^{n - 1} {SS}_{( i , j , k , l )} . \qquad [ 9 ]$$

wherein the actual areas sown thanks to the feeding cycles already performed (,l={1, . . . , n−1}) have been previously saved in the memory 21.

The computation of the projected total number of feeding cycles TNFC_{Proj(i,j,k,n)} Comprises:
determining a number of further feeding cycles to be performed as a function of the area still to be sown of the field S2S_{(i,j,k,n)} and the maximum area of the field sowable with one feeding cycle SS_{Max(i,j,k)}; and
calculating the projected total number of feeding cycles TNFC_{Proj(i,j,k,n)} by summing up the number of further feeding cycles to be performed with the number of feeding cycles already performed.

Hence, the projected total number of feeding cycles TNFC_{Proj(i,j,k,n)} is calculated by the following formula:

$$T N F {C}_{Proj ( i , j , k , n )} = n - 1 + Roundup ( \frac{S 2 {S}_{( i , j , k , n )}}{S {S}_{Max ( i , j , k )}} ) . \qquad [ 10 ]$$

The area still to be sown of the field S2S_{(i,j,k,n)} and/or the projected total number of feeding cycles TNFC_{Proj(i,j,k,n)} belong to the output data and are therefore displayed to the operator by the display 20 and saved in the memory 21.

The main advantage of the method and the managing system described above is to help an operator of a farm to limit the movements of the planter 1 along the field to be sown and therefore further reduce the downtime for planting. Indeed, normally a single tractor 6 is used to tow the planter 1 and the seed tender 7. By observing the output data, the operator can decide on whether to anticipate one or more feeding cycles during the entire planting process.

1. A method to manage the seed feeding of at least one planter through a seed tender for allowing the at least one planter to sow a seed into the soil of a field, the at least one planter including a plurality of hoppers for containing and dropping the seed, and the seed tender comprising a reservoir for the seed and a weighting system, which comprises gravimetric sensors applied to the reservoir, a human-machine interface, and a control unit provided with a memory for controlling the operation of the seed tender, the method comprising:
by the human-machine interface, acquiring input data comprising a total area of the field, a seeding surface density, a seed grain weight, a number of hoppers of the planter, optionally a maximum hopper capacity, and, for at least one feeding cycle of a plurality of feeding cycles, wherein the feeding cycle is for feeding all the hoppers of the planter and the plurality of feeding cycle is for allowing the planter to sow the entire field, acquiring a request of determining the actual hopper capacity before performing said at least one feeding cycle;
by the gravimetric sensors, acquiring weight measurements of the reservoir content;
by the control unit, processing the input data and the weight measurements in order to obtain output data;
by the human-machine interface, displaying the output data;
wherein processing the input data and the weight measurements comprises:
if the input data do not comprise the maximum hopper capacity, determining the maximum hopper capacity on the basis of weight measurements acquired during a feeding operation of an initially empty single hopper of the planter;
for each feeding cycle, incrementing a counter to record a number of feeding cycles already performed,
for each feeding cycle, from the second feeding cycle of the plurality of feeding cycles, executing the following steps:
if said request is acquired in the current feeding cycle, then determining an actual hopper capacity on the basis of weight measurements acquired during a feeding operation of a initially non empty single hopper of the planter before performing the feeding cycle, and computing an actual area sown by the planter with the preceding feeding cycle as a function of the input data and the actual hopper capacity, otherwise computing the actual area sown by the planter with the preceding feeding cycle (SS) as a function of the input data and the maximum hopper capacity,
saving in the memory said actual area sown by the planter with the preceding feeding cycle, and
computing an area still to be sown of the field and/or a projected total number of feeding cycles required to complete the sowing of the field as a function of the total area of the field, the number of feeding cycles already performed and the actual area sown by the planter with the feeding cycles already performed;
the area still to be sown of the field and/or the projected total number of feeding cycles required to complete the sowing of the field being part of the output data.

2. The method according to claim 1, wherein the maximum hopper capacity is determined by obtaining a hopper capacity on the basis of weight measurements acquired during a feeding operation of a single hopper of the planter when said single hopper is empty at the starting of said feeding operation, ad the actual hopper capacity is determined by obtaining a hopper capacity on the basis of weight measurements acquired during a feeding operation of a single hopper of the planter when said single hoper is not empty at the starting of said feeding operation.

3. The method according to claim 2, wherein obtaining a hopper capacity on the basis of weight measurements acquired during the feeding of a single hopper of the planter comprises:
by the control unit, operating the seed tender so as to feed the single hopper until it is full;
by the gravimetric sensors, measuring a first weight and a second weight of the reservoir content before and, respectively, after the feeding of the single hopper; and
by the control unit, calculating the hopper capacity as the difference between the first weight and the second weight.

4. The method according to claim 1, wherein processing the input data comprises:
computing a minimum total number of feeding cycles required for sowing the complete field as a function of the input data, the maximum hopper capacity and by assuming that at the start of each feeding cycle the hoppers are empty, the minimum total number of feeding cycles being part of the output data.

5. The method according to claim 1, wherein the actual area sown by the planter with the preceding feeding cycle is computed as a function a subset of the input data, in particular the number of hoppers of the planter, the seed grain weight, and the seeding surface density.

6. The method according to claim 1, wherein the area still to be sown of the field is computed as a difference between the total area of the field and the actual area sown by the planter with the feeding cycles already performed.

7. The method according to claim 1, wherein computing a projected total number of feeding cycles required to complete the sowing of the field comprises:
computing the maximum area of the field sowable by the planter with one feeding cycle as a function of a subset of the input data consisting of the number of hoppers of the planter, the seed grain weight and the seeding surface density, and as a function of the maximum hopper capacity;
determining a number of further feeding cycles to be performed as a function of the area still to be sown of the field and the maximum area of the field sowable by the planter with one feeding cycle; and
calculating the projected total number of feeding cycles (TNFC) required to complete the sowing of the field by summing the number of further feeding cycles to be performed with the number of feeding cycles already performed.

8. The method according to claim 1, wherein the weighting system comprises a wireless communication module for communicating with a personal communication device, the method comprising:
configuring the personal communication device with a software application designed for implementing at least one function selected among the group comprising a remote control function, a data transfer function, an equipment maintenance function, a reporting function;
controlling the operation of actuators of the seed tender and the operation of the weighting system by the personal communication device through the remote control function;
transmitting the output data to a cloud server by the personal communication device through the data transfer function;
sending warning messages to the weighting system by the personal communication device through the equipment maintenance function; and
providing statistical and traceability reports on the operations performed by the planter.

9. A method to manage the seed feeding of at least one planter through a seed tender for allowing the planter to sow a seed into the soil of at least one field, the at least one planter including a plurality of hoppers for containing and dropping the seed, and the seed tender comprising a reservoir for the seed and a weighting system, which comprises gravimetric sensors applied to the reservoir for measuring the weight of the reservoir content, a human-machine interface, and a control unit for controlling the operation of the seed tender, the method comprising:
by the gravimetric sensors, acquiring weight measurements;
by human-machine interface, for at least one feeding cycle of a plurality of feeding cycles, wherein the feeding cycle is for feeding all the hoppers of the planter and the plurality of feeding cycles is for allowing the planter to sow the entire field, acquiring request of determining the actual hopper capacity before performing said at least feeding cycle;
by the control unit, if said request is acquired, calculating an actual hopper capacity on the basis of weight measurements acquired during the feeding of a single hopper of the planter;
by the human-machine interface, if said request has been acquired, displaying the actual hopper capacity.

10. The method according to claim 9, wherein calculating an actual hopper capacity on the basis of weight measurements acquired during the feeding of a single hopper of the planter comprises:
by the control unit, operating the seed tender so as to feed the single hopper until it is full;
by the gravimetric sensors, measuring a first weight and a second weight of the reservoir content before and, respectively, after the feeding of the single hopper; and
by the control unit, calculating the hopper capacity as the difference between the first weight and the second weight.

11. A weighting system for a seed tender for the feeding of at least one planter for allowing it to sow a seed into the soil of at least one field, the seed tender comprising a reservoir for the seed and the weighting system, which comprises gravimetric sensors appliable to the reservoir, a human-machine interface, and a control unit provided with a memory for controlling the operation of the seed tender; the weighting system being configured for performing the method according to claim 1.

12. A managing system to manage the seed feeding of at least one planter through a seed tender for allowing the planter to sow a seed into the soil of at least one field, the managing system comprising a weighting system, which is according to claim 11 and comprises a wireless communication module for allowing the weighting system to communicate with a personal communication device, a cloud server, and a software application, which is installable on the personal communication device and is designed for configuring the personal communication device to be used as a remote control for controlling the operation of actuators of the seed tender and the operation of the control unit of the weighting system, and/or as a gateway between the weighting system and cloud server for transmitting the output data to the server and sending warning messages of equipment maintenance to the weighting system.
